(19) United States
(12) Patent Application Publication
(10) Pub. No.: US 2025/0244228 A1
(43) Pub. Date: Jul. 31, 2025

(54) METHOD AND SYSTEM FOR ASCERTAINING A COMPACTION STATE OF A HARVESTED MATERIAL

(71) Applicant: DEERE & COMPANY, MOLINE, IL (US)

(72) Inventors: AXEL FLEMMING, LIMBURGERHOF (DE); STEFAN BROCKE, MANNHEIM (DE)

(21) Appl. No.: 19/018,297

(22) Filed: Jan. 13, 2025

(30) Foreign Application Priority Data
Jan. 31, 2024 (DE) 102024102732.0

(51) Int. Cl. G01N 19/02; A01F 25/16; G07C 5/02

(52) U.S. Cl. CPC G01N 19/02; A01F 25/16; G07C 5/02

(57) ABSTRACT

The disclosure relates to a method for ascertaining a compaction state of a stored harvested material, whereof the surface is driven over by a utility vehicle for compaction purposes, the compaction state being ascertained according to at least one vehicle parameter which comes into effect while driving over the surface of the harvested material. The at least one vehicle parameter may include a traction coefficient, a slip, a tractive force, and a load force. The disclosure furthermore relates to a system having a control unit for carrying out such a method.

### CROSS-REFERENCE TO RELATED APPLICATIONS

This application claims priority to German Patent Application No. 102024102732.0, filed Jan. 31, 2024, which is hereby incorporated by reference.

### TECHNICAL FIELD

The present disclosure relates generally to a method and a system for ascertaining a compaction state of a stored harvested material whereof the surface is driven over by a utility vehicle for compaction purposes.

### BACKGROUND

In agriculture, it is known to gather swathes of cut grass and transport it to a storage site (e.g. silo). The stored grass is used in the form of silage as feed material. Careful compaction of the stored cuttings is important to avoid degradation of the feed and unnecessary storage costs. However, a relatively complex operation is required to achieve optimal compaction.

### SUMMARY

The object of the present disclosure is to improve the efficiency of the compaction of a stored harvested material.

This object is achieved by a method having the features of one or more embodiments disclosed herein and a system having the features of one or more embodiments disclosed herein.

According to one or more embodiments disclosed herein, a method is proposed for ascertaining a compaction state of a stored harvested material whereof the surface is driven over by a utility vehicle for compaction purposes. The compaction state here is ascertained according to one or more vehicle parameters which come into effect while driving over the surface of the harvested material. As vehicle parameters, at least one of the following parameters is provided: a traction coefficient of the utility vehicle or one or more vehicle wheels, a slip of the utility vehicle or one or more vehicle wheels, a tractive force of the utility vehicle or one or more vehicle wheels, a load force on the utility vehicle, i.e. in a wheel load or axle load.

Depending on the physical-mathematical approach of the method, the vehicle parameters may relate to a value of the utility vehicle as a whole or to the values of individual vehicle wheels.

The compaction of the stored harvested material (e.g. stored in a silo) is part of the manufacturing process for silage as animal feed. For example, a biomass of agricultural land, preferably grass or the non-fruit component of corn, millet or other cereals, is used as harvested material.

Taking into account at least one of the above-mentioned vehicle parameters, a current compaction state of the stored harvested material may be ascertained in real time while driving over the surface of the harvested material. The technical complexity for this is extremely low since the current values of the vehicle parameters can be provided via sensors and/or calculation algorithms in a technically simple manner. For example, individual vehicle parameters or all vehicle parameters may be provided via a system bus (e.g. ISO, CAN) of the utility vehicle. An awareness of the current compaction state aids the efficient driving operation of the utility vehicle since the compaction task may be terminated when a desired and ascertainable compaction state is achieved. In other words, the quality, for example, feed quality, of the stored and compacted harvested material may be improved, while the efficiency of the compaction task is simultaneously increased. As a result, high-quality animal feed may be produced with low operating costs. An awareness and monitoring of the continuously ascertainable current compaction state of the stored harvested material relieves the pressure on a worker (e.g. vehicle driver) during the compaction task and helps him to make decisions for efficient compaction work. For example, during the driving operation of the utility vehicle, the worker may decide in real time whether sufficient compaction has been achieved. Moreover, electronic processing of the current compaction state ascertained in each case may aid at least partial automation of the compaction task.

The ascertained compaction state may be represented, for example, by an absolute numerical value or by a percentage value. As percentage values, e.g. 0% may be used for a non-compacted state, 100% may be used for a fully compacted state and values between 0% and 100% may be used for a corresponding partially compacted state of the harvested material.

In an embodiment, the traction coefficient and/or the slip may be compared with provided reference data. The compaction state to be ascertained may be derived from the comparison result. In other words, the sought compaction state is ascertained according to the comparison result. As a result, vehicle parameters are compared to reference data so that the current compaction state can be ascertained with a low level of technical and algorithmic complexity.

For example, various reference densities (e.g. in absolute numerical values of a density or in percentage readings) are assigned to the reference data, which facilitates the ascertainment of the current compaction state of the stored harvested material on the basis of the above-mentioned comparison result. The reference data may be in the form of specific data for known driving surfaces and/or for at least one known type of harvested material (e.g. grass or silage).

The reference data may represent a relationship between a reference traction coefficient and a reference slip for different driving surfaces and/or for different compaction states of at least one type of harvested material, for example the harvested material which is currently being processed in a compaction task.

The reference data may be generated via previous calibration procedures (e.g. relating to various driving surfaces and/or various types of stored harvested material). The reference data may be provided in a suitable technical form, for example in a database or data center for data retrieval.

The estimation or ascertainment of the current compaction state of the stored harvested material is additionally facilitated if the different compaction states of the harvested material which are provided as reference data represent at least a fully compacted state (100% compaction) and a non-compacted state (0% compaction) of the harvested material. This enables a comparison of the current traction coefficient and/or the current slip with the two above-mentioned extreme states, whereby the current compaction state may be estimated or ascertained quantitatively during the compaction task in a particularly accurate manner.

The reference data may be provided, for example, as at least one characteristic curve or as a data table. For example, the reference data are provided in the form of a curve family. Different characteristic curves may represent different driving surfaces. Individual characteristic curves may represent a certain type of harvested material. Multiple characteristic curves may also represent different compaction states of the same type of harvested material. Multiple characteristic curves can aid the worker during the compaction task in a convenient manner if, for example, both the current values of the traction coefficient and the slip and also the curve family are represented visually on a display unit (e.g. on a screen). As a result, the worker is able to identify the current status or the current compaction state during the compaction task in a simple visual representation. Moreover, the progress of the compaction task may be identified directly.

The current values of the vehicle parameters while driving over the surface of the harvested material may be determined via suitable sensors and/or calculation algorithms, as already mentioned.

The slip may be determined according to the vehicle speed and the speed of a vehicle wheel or a vehicle axle. The vehicle speed here may be detected, for example, via a receiver of a position detection system (e.g. GPS), a ground radar or a detected wheel speed of a vehicle wheel on a non-driven vehicle axle. The wheel speed of a vehicle wheel may be detected via a speed sensor on this vehicle wheel or on the vehicle axle thereof.

The axle load may be detected or calculated via suitable sensors (e.g. pressure sensors in the suspension, sensors on the vehicle tires or the vehicle axles). For example, the axle load is a dynamic axle load, which differs from a constant or static axle load as a result of driving over the surface of the harvested material. When calculating the axle load, measured variables of the utility vehicle dynamics (e.g. pitching, rolling), a front and/or rear ballast weight and known static axle loads of the utility vehicle may be taken into account.

Current values of the traction coefficient may be detected, for example, via specific sensors on the utility vehicle. Alternatively, the traction coefficient is detected with a low level of technical complexity, in that it is determined according to the axle load and/or the tractive force. In particular, the calculation formula

$$k\_tr = F\_tr / F\_la$$

may be used to determine the traction coefficient k_tr of a vehicle wheel. F_tr here is the above-mentioned tractive force and F_la is the load force or wheel load of the relevant vehicle wheel, the wheel load F_la being derivable from a known axle load or being detectable via a load sensor.

The tractive force F_tr itself may be determined either by at least one sensor (e.g. on a driven vehicle axle) or from a calculation. In the case of a calculation, the tractive force may be determined according to at least one of the following variables: a torque of the utility vehicle, e.g. of the drive train or a vehicle wheel, a radius of a vehicle wheel of the utility vehicle, or a friction force (rolling friction) of the utility vehicle, e.g. of a vehicle wheel, which opposes the tractive force.

This may be based on the principle physical correlation according to which the tractive force or driving force is the resultant force of the propulsion provided by a torque of the drive train and the opposing rolling friction of the vehicle wheels.

For example, the calculation formula

$$F\_tr = ( M\_rad / R\_rad ) - F\_ro$$

may be used to calculate the tractive force of an individual vehicle wheel. Here, F_tr is the tractive force, M_rad is the drive torque or torque of the vehicle wheel, R_rad is the radius of the vehicle wheel or tire and F_ro is the friction force or the rolling friction of the vehicle wheel on the driving surface. The drive torque M_rad can be derived from the total drive torque of the drive train or via a torque sensor.

To ascertain the current compaction state with even greater accuracy, at least one of the following items of information (1)-(3) is additionally taken into account: (1) At least one further item of information relating to the utility vehicle. This may be various vehicle data (e.g. tire pressure, vehicle speed). The at least one item of information or the vehicle data may be provided, for example, directly via corresponding sensor signals or via a system bus (e.g. ISO, CAN) of the utility vehicle. (2) At least one item of information characterizing the harvested material. It is possible to distinguish, for example, between cut grass and various cereals here. The information may also represent a biological state of the harvested material (e.g. fresh or wilted). (3) A moisture content of the harvested material.

A compaction state is advantageously ascertained in each case in multiple surface sections along the surface of the stored harvested material that is to be compacted. As a result, individual surface sections of the harvested material may be driven over more or less frequently than other surface sections in order to achieve uniform compaction along the surface of the harvested material in an efficient manner.

The ascertained compaction state may be represented visually on a display unit. The ascertained compaction state may be represented, for example, directly as a concrete numerical value or as a mark or characteristic curve within the provided curve family of the reference data, which represent specific compaction states and may likewise be represented visually. In the case of the above-mentioned section-related compaction states, a visual representation of the surface of the harvested material that is divided into surface sections is advantageous, with different section-related compaction states being represented by different colors of the surface sections.

The display unit (e.g. screen) may be part of a user interface for inputting, displaying and outputting data or information. The display unit may be arranged within the utility vehicle, or it may be, for example, part of a mobile or portable device outside the utility vehicle.

The disclosure further relates to a system for ascertaining a compaction state of a stored harvested material, having a utility vehicle for driving over the surface of the stored harvested material and having a control unit. The control unit may include a processor and a memory, and various algorithms are stored therein. The control unit may ascertain the compaction state according to at least one of the following vehicle parameters: a traction coefficient, a slip, a tractive force, or a load force. The control unit is configured to compare at least one of the traction coefficient or the slip with reference data and configured to ascertain the compaction state according to the comparison result. The reference data represents different reference compaction states of the harvested material. The control unit is also configured to determine the tractive force according to at least one of the following variables: a torque of the utility vehicle, a radius of a vehicle wheel of the utility vehicle, or a friction force of the utility vehicle, which opposes the tractive force. The control unit is configured to ascertain the compaction state according to at least one of the following items of information: at least one further item of information relating to the utility vehicle, an item of information characterizing the harvested material, or a moisture content of the harvested material.

The system according to the disclosure has the above-described advantages of the method according to the disclosure. The control unit may comprise suitable algorithms for ascertaining a compaction state of the stored harvested material. The system enables data to be provided, which are oriented toward a setpoint compaction state of the stored harvested material. This aids high-quality feed production (e.g. silage) along with efficient operation of the utility vehicle. The ability to continuously ascertain the current compaction state of the harvested material by the method relieves the pressure on the vehicle driver and also other workers during the compaction task. Moreover, ascertained values of the compaction state may serve as a realistic database for automation of an efficient work process during the compaction of the stored harvested material.

In relation to the ascertained current compaction state, the control unit may generate various further data which may aid a worker via further information and/or which may aid the control of the utility vehicle during the compaction task. For example, any necessary remaining compaction or a setpoint compaction which depends on the harvested material (e.g. the type, biological state, moisture content) may be calculated via specific algorithms of the control unit. Depending on the ascertained current compaction state, the utility vehicle may be controlled via the control unit in order to make the operation of said utility vehicle more efficient. In this regard, relevant vehicle parameters, for instance the tire pressure, the vehicle speed, the steering or the track of the vehicle, may be controlled via the control unit in a desired manner.

For example, various types of agricultural utility vehicles (e.g. tractors, shovel loaders, telescopic loaders) are suitable utility vehicles. Autonomous vehicles without vehicle drivers or remote controlled vehicles are also conceivable.

In an embodiment, the control unit is integrated in the utility vehicle. It may be connected, for example, to a system bus (e.g. ISO, CAN) and/or to other function units of the utility vehicle. The data exchange that is possible as a result may aid precise and efficient functionality of the system.

The system further may have at least one of the following components (1)-(4), which is connected to the control unit via a data connection:
(1) A user interface for inputting and/or visually representing data. As a result, user-based data, in particular data coming from the vehicle driver, may be taken into account in a technically simple manner when ascertaining the compaction state. Moreover, the current compaction state and the progress of the compaction process may be represented visually, which relieves the pressure on the worker or the vehicle driver during the compaction task.
(2) A position detection system (e.g. GPS receiver and, if applicable, further components), which may be arranged on the agricultural utility vehicle.
(3) A data center containing data which are generated and/or provided while carrying out the method, including the control unit ascertaining the compaction state according to at least one of the vehicle parameters such as the traction coefficient, the slip, the tractive force, or the load force. As a result, the control unit may efficiently access data which are relevant for ascertaining the compaction state and for monitoring the compaction progress.
(4) A database containing reference data which represent different reference compaction states of at least the harvested material of the current compaction task. This aids the supply of data material to the control unit for precisely ascertaining the density of the stored harvested material.

Other features and aspects will become apparent by consideration of the detailed description, claims, and accompanying drawings.

### BRIEF DESCRIPTION OF THE DRAWINGS

The disclosure is explained in greater detail below with reference to the appended drawings. Component parts of equivalent or comparable function are identified by the same reference signs in this case. In the drawings:

FIG. 1 shows an illustration in the manner of a block diagram of the system according to the disclosure,

FIG. 2 shows an illustration in the manner of a block diagram of details of the method according to the disclosure,

FIG. 3 shows a curve family with a correlation between a traction coefficient and slip,

FIG. 4A shows a schematic plan view of a utility vehicle and a harvested material to be compacted,

FIG. 4B shows a side view of the utility vehicle and the harvested material to be compacted according to the arrow direction IV-B in FIG. 4A.

Like reference numerals are used to indicate like elements throughout the several figures.

### DETAILED DESCRIPTION

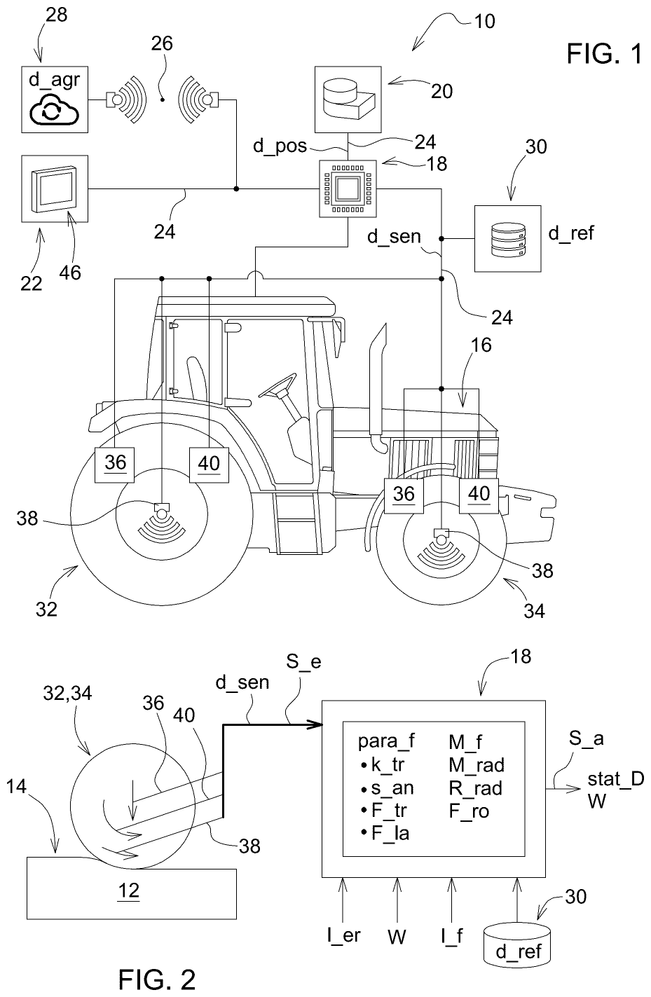

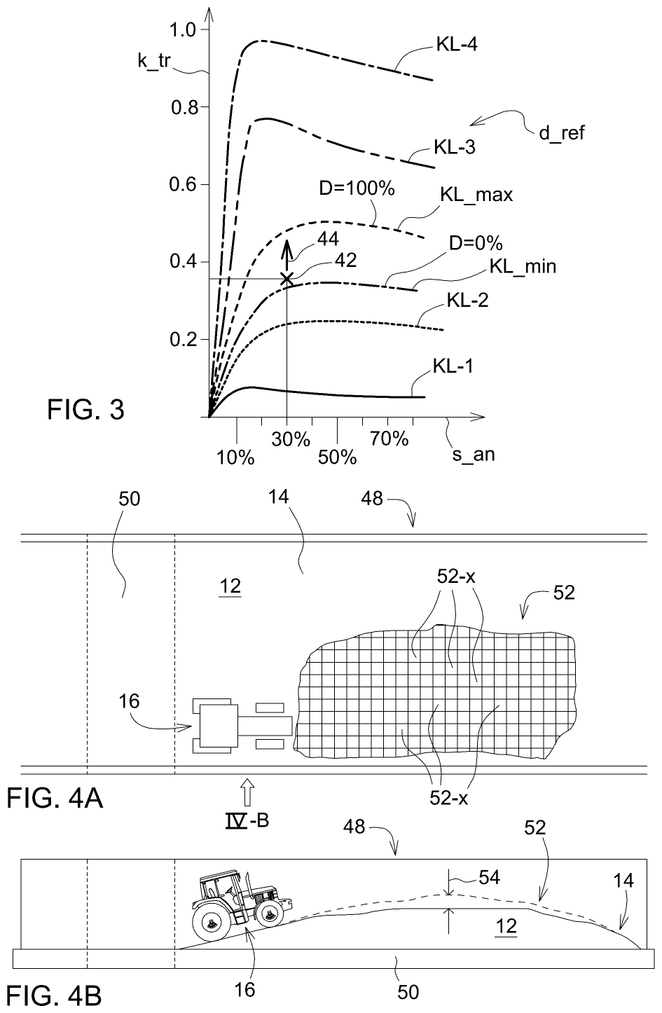

FIG. 1 shows a system 10 for ascertaining a compaction state stat_D of a stored harvested material 12, whereof the surface 14 is driven over by an agricultural vehicle 16, here the form of a tractor, for compaction purposes. The ascertained compaction state stat_D is output via output signals S_a of a control unit 18. The output signals may optionally moreover include a moisture content W of the harvested material 12 and further data of interest in relation to the compaction task.

The control unit 18 may be integrated in the utility vehicle 16. The utility vehicle 16 is controlled, for example, by a vehicle driver or is active in an automated manner as an autonomous vehicle.

The utility vehicle 16 and further components of the system 10 are connected to the control unit 18 via a suitable data connection in order to ascertain the compaction state stat_D and to communicate this to a worker (e.g. the vehicle driver) in particular in a visual manner.

A position detection system 20 (e.g. GPS) and a user interface 22 (e.g. keyboard and display unit 46 for inputting and/or visually representing data) are arranged in or on the utility vehicle 16 and are each connected to the control unit 18 via a wired data connection 24. The control unit 18 is connected to a data center 28 via a wireless data connection 26. The data center may be based on Cloud technology. It may serve as a central data storage device and/or data processing center for various agriculture-related activities of a farmer or on a farm. The data center 28 includes, inter alia, various agriculture-related data d_agr. At least some of these data d_agr may be generated, and stored in the data center 28, while carrying out the method for ascertaining the compaction state stat_D and/or they may be provided by the data center 28 before, and therefore also while, carrying out the method. For example, the control unit 18 sends various output signals S_a, for example, the current compaction state stat_D, to the display unit 46 for visually representing the compaction state stat_D in real time and simultaneously transmits these output signals S_a to the data center 28 via the data connection 26.

Moreover, a database 30 containing reference data d_ref is connected to the control unit 18 via a further wired data connection 24. The reference data d_ref are explained in more detail with reference to FIG. 3.

Taking into account various vehicle parameters para_f, the control unit 18 may ascertain the compaction state stat_D. Various sensors are arranged on the utility vehicle 16 in order to detect the values of various vehicle parameters para_f directly while driving over the surface 14 of the harvested material 12 or to calculate these values in the control unit 18 using the generated sensor data d_sen. The sensor data d_sen of the sensors are transmitted to the control unit 18 via a further wired data connection 24 here.

The above-mentioned sensors are arranged in the region of the rear wheels 32 and the front wheels 34. In the exemplary embodiment, the sensors comprise a load sensor 36, a slip sensor system 38 and a torque sensor 40.

In a further function, the control unit 19 may be used to control the utility vehicle 16 according to the ascertained current compaction state stat_D in order to aid the operation of said utility vehicle. In this regard, relevant vehicle parameters, for instance the tire pressure, the vehicle speed or the steering, may be controlled via the control unit 18.

FIG. 2 shows the control unit 18, which receives, inter alia, the sensor data d_sen as input signals S_e. The sensor data d_sen are assigned to one or both rear wheels 32 and/or one or both front wheels 34.

The control unit 18 may receive further information or variables at least one additional signal input. These are, for example: at least one further item of information I_f relating to the utility vehicle 16, e.g. tire pressure; an item of information I_er characterizing the harvested material 12; or a moisture content W of the harvested material 12.

The above-mentioned information or variables can be retrieved from other data sources or they may be input manually via the user interface 22 or they may be provided by measurements. The control unit 18 does not necessarily have to be provided with all of the above-mentioned information or variables. For example, the moisture content W and the information I_er characterizing the harvested material 12 are items of information which are optionally received by the signal processing unit 18 in each case. Furthermore, other information or variables not mentioned here may be optionally received by the control unit 18.

As already mentioned, the compaction state stat_D is ascertained according to multiple vehicle parameters para_f, for example, a traction coefficient k_tr and a slip s_an. The slip s_an may be ascertained here via the slip sensor system 38.

To determine or calculate the traction coefficient k_tr, the following mathematical-physical correlations are taken to account in the control unit 18 or in the algorithms thereof. The traction coefficient k_tr is defined as quotient

$$k\_tr = F\_tr / F\_la ,$$

F_tr being a tractive force and F_la being a load force. These two forces may be determined via suitable sensors. For example, the load force F_la may be determined directly via the load sensor 36.

Alternatively, the two above-mentioned forces may be calculated by firstly detecting other relevant vehicle variables. By way example, a calculation of the tractive force shall be given by the formula here.

$$F\_tr = ( M\_rad / R\_rad ) - F\_ro$$

M_f is a known torque of the drive train of the utility vehicle 16, R_rad is a known tire radius of the relevant vehicle wheel 32, 34 and F_ro is the friction force (rolling friction) of the utility vehicle 16 or the relevant vehicle wheel 32, 34, which opposes the tractive force F_tr. To assign the tractive force F_tr to an individual vehicle wheel 32, 34, the torque M_f of the drive train in the formula can be replaced by the torque M_rad of the relevant vehicle wheel 32, 34, which can be derived from the torque M_f.

In very general terms, the calculations of the vehicle parameters para_f and physical variables may relate to a value of the utility vehicle 16 as a whole or to the values of individual vehicle wheels 32, 34, depending on the physical-mathematical approach.

FIG. 3 shows, by way of example, reference data d_ref in the form of a curve family, whereof the characteristic curves represent different reference compaction states or reference compaction levels of the harvested material 12 to be compacted. The bottom characteristic curve KL_min represents a fully non-compacted state (D=0%), while the top characteristic curve KL_max represents a fully compacted state (D=100%) of the harvested material 12. Characteristic curves (not shown here) with other reference compaction states or reference compaction levels for the same harvested material may also be optionally provided here between these two characteristic curves KI_min, KL_max.

The curve family shows a correlation or relationship between the traction coefficient k_tr and the slip s_an for different reference compaction states of the harvested material 12 to be compacted. Likewise, the curve family may include reference compaction states (not shown) for other types of harvested material 12. For comparison purposes, in particular in the case of a visual representation for a worker, further characteristic curves are optionally also included in the curve family. These further characteristic curves may represent different driving surfaces, e.g. KL-1 (ice), KL-2 (mud), KL-3 (wet asphalt), KL-4 (dry asphalt).

As already mentioned above, the current traction coefficient k_tr and the current slip s_a may be determined via sensors and/or via calculations during the compaction task. This gives a current operating point 42, which, in the exemplary embodiment according to FIG. 3, is located above the characteristic curve KL_min. The control unit 18 may compare the operating point 42 with the reference characteristic curves KL_min, KL_max and derive the current compaction state stat_D according to the comparison result. As the compaction task continues, the operating points move in the direction of the characteristic curve KL_max, which indicates the progress of the compaction task. This progress is indicated in FIG. 3 by the arrow 44.

FIG. 4A and FIG. 4B show a silo 48 on the base plate 50 of which the harvested material 12 is stored. Material 54 of the harvested material 12 is to be compacted in a surface region 52. With the aid of position data d_pos of the utility vehicle 17, the surface region 52 may be divided into multiple surface sections 52-x for which a compaction state stat_D is ascertained in each case. The position-dependent compaction state stat_D may then be sent to the user interface 22 via the control unit 18. The surface 14 to be driven over, for example, the surface region 52, may thus be represented visually on the display unit 46 in real time, with current compaction states stat_D assigned section by section. Different compaction states stat_D may be represented by different colors. For example, non-compacted surfaces sections 52-c may be represented by a red color, fully compacted surface sections 52-x may be represented by a green color and surface sections 52-x having other compaction states or levels may be represented by corresponding color gradations.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for ascertaining a compaction state of a stored harvested material, whereof a surface is driven over by a utility vehicle for compaction purposes, comprising ascertaining the compaction state according to at least one of the following vehicle parameters which come into effect while driving over the surface of the harvested material: a traction coefficient, a slip, a tractive force, or a load force.

2. The method of claim 1, wherein at least one of the traction coefficient or the slip is compared with reference data and the compaction state is ascertained according to the comparison result.

3. The method of claim 2, wherein the reference data represents different reference compaction states of the harvested material.

4. The method of claim 3, wherein the different reference compaction states include at least 100% compaction and 0% compaction of the harvested material.

5. The method of claim 2, wherein the reference data is provided as a curve family.

6. The method of claim 1, wherein the traction coefficient is determined according to the load force or the tractive force.

7. The method of claim 6, wherein the tractive force is determined according to at least one of the following variables:
a torque of the utility vehicle,
a radius of a vehicle wheel of the utility vehicle, or
a friction force of the utility vehicle, which opposes the tractive force.

8. The method of claim 1, wherein the compaction state is ascertained according to at least one of the following items of information:
at least one further item of information relating to the utility vehicle,
an item of information characterizing the harvested material, or
a moisture content of the harvested material.

9. The method of claim 1, wherein a compaction state is ascertained in each case in multiple surface sections along the surface of the stored harvested material that is driven over.

10. The method of claim 1, wherein the ascertained compaction state is represented visually on a display unit.

11. A system for ascertaining a compaction state of a stored harvested material, comprising:
a utility vehicle for compacting the stored harvested material, and
a control unit configured for ascertaining the compaction state according to at least one of the following vehicle parameters: a traction coefficient, a slip, a tractive force, or a load force.

12. The system of claim 11, wherein the control unit is included in the utility vehicle.

13. The system of claim 11, wherein at least one of a user interface, a position detection system, a data center, or a database is part of the system and is connected to the control unit via a data connection.

14. The system of claim 13, wherein the user interface is configured for inputting or visually representing data.

15. The system of claim 13, wherein the data center includes data which is generated or provided while the control unit is ascertaining the compaction state according to at least one of the vehicle parameters.

16. The system of claim 13, wherein the database includes reference data which represents different reference compaction states of the harvested material.

17. The system of claim 11, wherein the control unit is configured to compare at least one of the traction coefficient or the slip with reference data and configured to ascertain the compaction state according to the comparison result.

18. The system of claim 17, wherein the reference data represents different reference compaction states of the harvested material.

19. The system of claim 11, wherein the control unit is configured to determine the tractive force according to at least one of the following variables:
a torque of the utility vehicle,
a radius of a vehicle wheel of the utility vehicle, or
a friction force of the utility vehicle, which opposes the tractive force.

20. The system of claim 11, wherein the control unit is configured to ascertain the compaction state according to at least one of the following items of information:
at least one further item of information relating to the utility vehicle,
an item of information characterizing the harvested material, or
a moisture content of the harvested material.
